(19) United States
(12) Patent Application Publication
(10) Pub. No.: US 2009/0322862 A1
(43) Pub. Date: Dec. 31, 2009

(54) AUTOSTEREOSCOPIC DISPLAY DEVICE

(75) Inventors: Michel Cornelis Josephus Marie Vissenberg, Eindhoven (NL); Willem Lubertus Ijzerman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,737

(22) PCT Filed: Aug. 23, 2007
(86) PCT No.: PCT/IB07/53373

§ 371 Date: Feb. 25, 2009

(30) Foreign Application Priority Data
Aug. 31, 2006 (EP) 06119925.3

(51) Int. Cl. H04N 13/04

(52) U.S. Cl. 348/59; 348/E13.075

(57) ABSTRACT

An autostereoscopic display device uses a converged backlight output, and the convergence is performed with a light converging arrangements (60,62) which preferentially converge light inwardly along a certain axis perpendicular to the elongate axis of the lenticular elements (11). This means that the amount of light directed at large angles sideways between the lenticular elements (11) is reduced to a minimum. This reduces the amount of light tunneling within the lenticular array and therefore improves the display output, in particular the brightness and contrast.

### FIELD OF THE INVENTION

This invention relates to an autostereoscopic display device of the type that comprises a display panel having an array of display pixels for producing a display and a plurality of imaging means, such as lenticular elements, arranged over the display panel and through which the display pixels are viewed.

### BACKGROUND OF THE INVENTION

A known autostereoscopic display device comprises a two dimensional liquid crystal display panel having a row and column array of display pixels acting as a spatial light modulator to produce the display. An array of elongate lenticular elements extending parallel to one another overlies the display pixel array, and the display pixels are observed through these lenticular elements.

The lenticular elements are provided as a sheet of elements, each of which comprises an elongate semi-cylindrical lens element. The lenticular elements extend in the column direction of the display panel, with each lenticular element overlying a respective group of two or more adjacent columns of display pixels. In an arrangement in which, for example, each lenticular element is associated with two columns of display pixels, the display pixels in each column provide a vertical slice of a respective two dimensional sub-image. The lenticular sheet directs these two slices, and corresponding slices from the display pixel columns associated with the other lenticular elements, to the left and right eyes of a user positioned in front of the sheet, so that the user observes a single stereoscopic image. The sheet of lenticular elements thus provides a light output directing function.

In other arrangements, each lenticular element is associated with a group of four or more adjacent display pixels in the row direction. Corresponding columns of display pixels in each group are arranged appropriately to provide a vertical slice from a respective two dimensional sub-image. As a user's head is moved from left to right, a series of successive, different, stereoscopic views are perceived creating, for example, a look-around impression.

### SUMMARY OF THE INVENTION

The above described device provides an effective three dimensional display. However, it will be appreciated that, in order to provide stereoscopic views, there is a necessary sacrifice in the horizontal resolution of the device. This sacrifice in resolution is unacceptable for certain applications, such as the display of small text characters for viewing from short distances.

A compromise has to be reached between the number of views per angle, which should be high for a good 3D impression, and the resolution per view, which is higher for a smaller number of views. A low number of perspective views will give a shallow 3D image with little perception of depth. The larger the number of views per angle, the more the perception of 3D will resemble that of a truly 3D image such as for example a holographic image.

In the case of an n-view 3D display with vertical lenticular lenses, the perceived resolution of each view along the horizontal direction will be reduced by a factor of n relative to the 2D case. In the vertical direction the resolution will remain the same.

It has been proposed to use lenticular elements that are slanted, and this can be used to reduce this disparity between the resolutions in the horizontal and vertical directions. In that case, the resolution loss can be distributed evenly between the horizontal and vertical directions.

A further problem associated with the use of a lenticular array is that there is a loss of brightness, and the sharpness of images can also be reduced.

A loss of brightness can result because light can be captured within the lenticular array as a result of refraction of the light by the lens surface, and by subsequent total internal reflection. This light can be tunneled within the material of the lenticular array, and thus does not contribute to the overall brightness of the output.

This tunneled light may also escape from the lenticular array from a different location, and this gives rise to cross talk between pixels, reducing the contrast of the display, with a deterioration of the quality of the black output state of the display. The result of this is in particular a blurring of edges between bright and dark regions of an output image.

The invention is defined by the independent claims. The dependent claims define advantageous embodiments.

The autostereoscopic display device according to the invention is based on the recognition that the amount of light that becomes tunneled within the lenticular array can be reduced by limiting the range of angles of incidence of the light which is directed to the lenticular array. This can be achieved by providing a partially collimated backlight output.

The partial collimation function preferably converges light to within a desired angle range, but maintains light at all angles within the desired range, so that multiple lenticular elements can be illuminated from a single portion of the display. The light converging function can thus be thought of as an angle capping function.

The light directing arrangement may be a single ideal converging arrangement that reduces the width of the light distribution in the direction perpendicular to the lenticulars.

However, the light directing arrangement may further comprise a second light converging arrangement for converging light towards a direction normal to the display panel and having a first axis across which the light convergence is greatest and second perpendicular axis across which the light convergence is least, and the first and second axes of the second light converging arrangement are substantially perpendicular to the first and second axes of the first light converging arrangement.

The first and second light converging arrangements may each comprise a prismatic film, for example a brightness enhancement film. These are widely available and provide a thin planar arrangement which can easily be fitted into the display structure, without requiring any accurate pixel alignment. These have imperfect light capping properties and do not completely eliminate light at large angles. The use of two crossed brightness enhancement foils improves the optical response.

When two crossed converging arrangements are used, convergence of the light from the backlight is provided using a two-stage convergence process with perpendicular principal axes. Thus, convergence is provided in one direction, and then in a perpendicular direction. One of these directions is perpendicular to the lenticular element axis, and this means the spread of light sideways from one lenticular element to the adjacent lenticular elements on each side is reduced. Thus, the axial alignment of the light collimation function is matched to the physical structure of the lenticular elements (and not necessarily the row and column directions), so that the resulting capture of light with the lenticular array through total internal reflection is reduced or eliminated. This results in enhanced contrast and brightness levels and a reduction in image artefacts resulting from optical cross talk.

The elongate axis of the lenticular elements is preferably offset from the pixel column direction. The backlight is preferable a planar backlight.

The device may be adapted to provide a central image and a number of repetitions of the image directed to different spatial locations by the lenticular array. The repetitions may comprise N of pairs of image repetitions (i.e. one central image and N side images on each side of the central image), wherein the maximum number of view repetitions is defined by the equation:

$${N}_{MAX} = trunc [ \frac{d}{p \sqrt{{n}^{2} - 1}} - \frac{1}{2} ]$$

wherein Nₘₐₓ is the maximum number of pairs of image repetitions, n is the refractive index of the material of the lenticular array, d is the effective normal distance between the display panel pixels and the lenticular array, and p is the lenticular element pitch.

This equation sets the maximum number of view repetitions in such a way that view repetitions are not provided if the resulting angle of light from a pixel to the lenticular element which will provide the view repetition will result in total internal reflection within the lenticular array.

The maximum angle from a display pixel to a lenticular element which is to provide a view repetition can then be defined by the equation:

α_{MAX}=arctan [(N_{MAX}+½)p/d].

This specifies the maximum angle of light emission needed from the pixel for the pixel to be able to illuminate the lateral lenticular element which is needed for the last view repetition. This maximum angle can then be used to design the light converging arrangements. In particular, the light converging arrangement having its second axis aligned with the elongate axis of the lenticular elements can be adapted to provide light collimation such that light within the lenticular array is substantially limited to light having a lateral divergence from the normal of less that the angle α_{MAX}.

By “lateral” in the above contexts is meant in a direction perpendicular to the elongate axis of the lenticular elements, namely in the sideways direction of the lenticular elements.

The invention also provides a method of providing an autostereoscopic display using a display panel comprising an array of rows and columns of pixels and a lenticular array over an output surface of the display panel, the lenticular array comprising a plurality of elongate lenticular elements, the method comprising:
providing a light output from a backlight;
passing the light output through a first light converging arrangement for converging light towards a direction normal to the display panel and having a first axis across which the light convergence is greatest and a perpendicular second axis across which the light convergence is least, wherein the second axis of the light converging arrangement is aligned with the elongate axis of the lenticular elements.

### BRIEF DESCRIPTION OF THE DRAWINGS

An embodiment of the invention will now be described, purely by way of example, with reference to the accompanying drawings, in which:

FIG. 1 is a schematic perspective view of a known autostereoscopic display device;

FIG. 2 is a schematic plan view of the known display device shown in FIG. 1;

FIG. 3 is used to show how the output images are formed from the known autostereoscopic display devices.

FIG. 4 shows the way light rays pass through the structure of FIGS. 1 to 3;

FIG. 5 is an enlarged view of part of FIG. 4;

FIG. 6 is a schematic perspective view of an autostereoscopic display device of the invention; and

FIG. 7 shows the way light rays pass through the structure of FIG. 6.

### DETAILED DESCRIPTION OF AN EMBODIMENT

The invention provides an autostereoscopic display device in which a partially collimated backlight output is used, and the partial collimation is performed a light convergence function which preferentially converges light inwardly along an axis perpendicular to the elongate axis of the lenticular element, and this means that the amount of light directed at large angles sideways between the lenticular elements is reduced to a minimum. This reduces the amount of light tunneling within the lenticular array and therefore improves the display output, in particular the brightness and contrast.

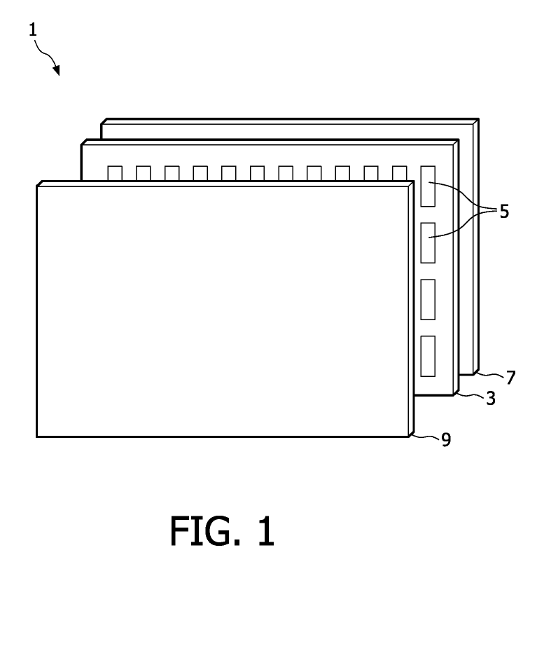

FIG. 1 is a schematic perspective view of a known direct view autostereoscopic display device 1. The known device 1 comprises a liquid crystal display panel 3 of the active matrix type that acts as a spatial light modulator to produce the display.

The display panel 3 has an orthogonal array of display pixels 5 arranged in rows and columns. For the sake of clarity, only a small number of display pixels 5 are shown in the Fig. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9 arranged over the display side of the display panel 3. The lenticular sheet 9 comprises a row of lenticular elements extending parallel to one another.

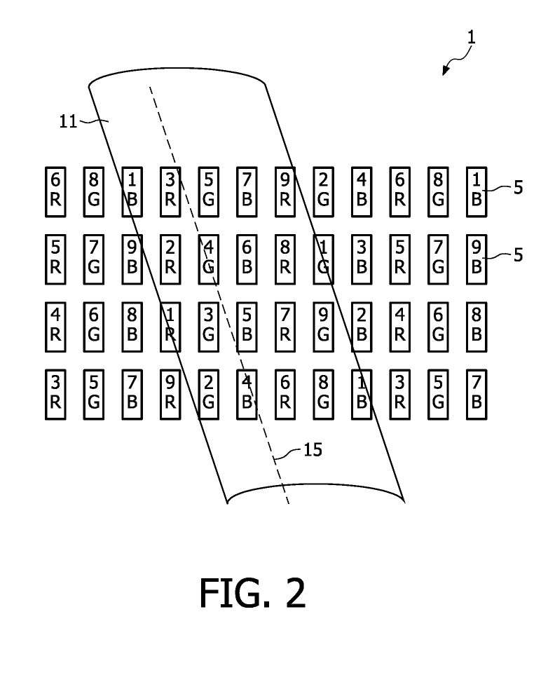

The arrangement of the display pixels 5 and lenticular elements 11 is shown more clearly in FIG. 2, which is a schematic plan view of the display device 1 shown in FIG. 1. Again, only a small number of the display pixels 5 are shown for the sake of clarity.

A known configuration for the lenticular element is shown in FIG. 2. The lenticular elements 11, of which only one is shown, are slanted at an angle to the column direction of the display pixels 5, i.e. their longitudinal axis defines an acute angle with the column direction of the display pixels 5. This acute angle is typically less than 25 degrees, and more typically less than 15 degrees.

FIG. 2 also shows that the pixels are divided into sub-pixel color triplets. The numbers marking the pixels in FIG. 2 represent the view numbers for a nine view display, and the dotted line 15 shows how one viewing position with respect to the lenticular element 11 enables only one view (view 4) to be seen. This shows that the display design can provide a large number of views, although in practice the loss of resolution means a smaller number of views may be preferred.

The lenticular elements 11 are in the form of convex cylindrical lenses, and they act as an optical director means to provide different images, or views, from the display panel 3 to the eyes of a user positioned in front of the display device 1. The lenticular elements 11 also provide a number of different images, or views, to the eyes of the user as the user's head moves from left to right in front of the display device 1. This preferred lenticular arrangement allows the reduction in vertical and horizontal resolution to be matched as explained above.

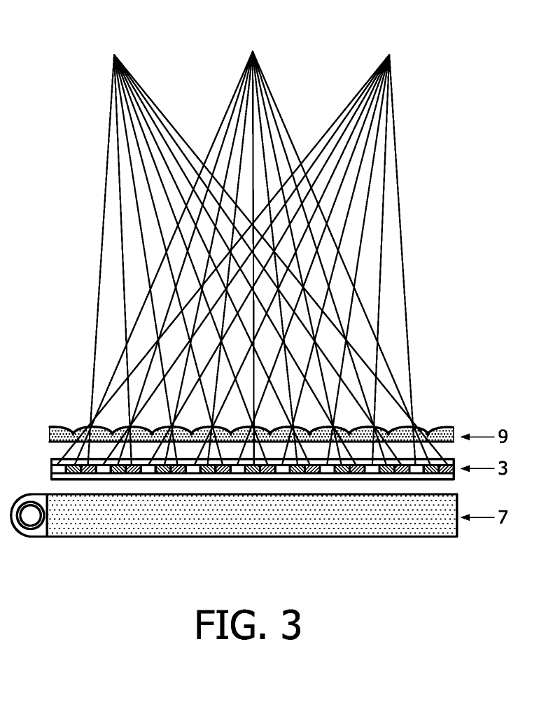

FIG. 3 shows the principle of operation of the lenticular type imaging arrangement as described above and shows the backlight 7, the display device 3 such as an LCD and the lenticular array 9.

It can be understood from FIG. 3 that the number of locations to which a pixel is imaged by the lenticular array corresponds to the number of different views provided by the display device.

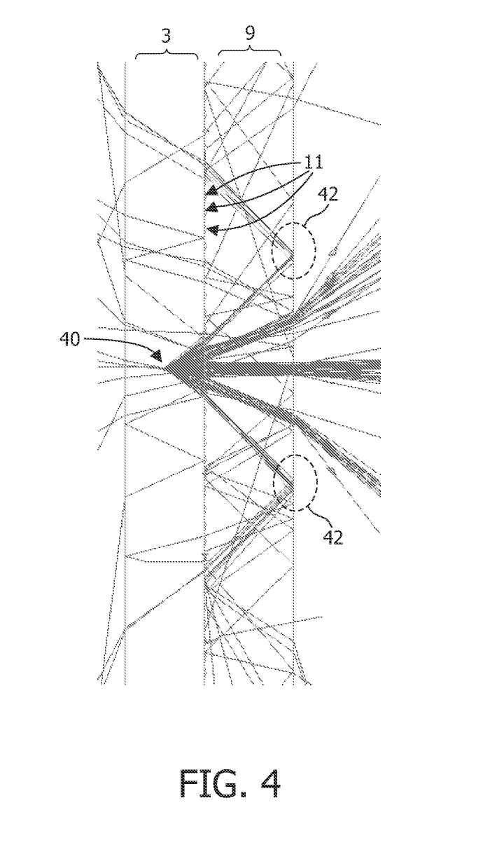

FIG. 4 is used to explain the problem of light tunneling which can result when light from different angles falls on the lenticular array.

FIG. 4 shows the display panel 3 and the overlying lenticular array 9, and shows a cross section through the row of individual lenses 11. Thus, the image is looking down in the direction of the elongate axis of the lenticular elements.

Light is shown entering the display panel 3 at all directions.

The light which reaches a particular pixel 40 is modulated by the pixel, The range of angles of incidence of light to the pixel 40 dictates the range of angles of the modulated light exiting the pixel. Thus, control of the illumination source enables control of the pixel output direction.

Refraction of the light occurs at the lenticular surface, and this increases further the range of angles of light which then travels within the lenticular array 9.

As shown in FIG. 4, the optical function of the lenticular elements 11 is to divide the light from the pixel into a central viewing direction and repetitions of this view (i.e. the same pixel information but viewed through a different lenticular element) at larger angles. These repetitions enable multiple users to view the display from different viewing positions.

Some of the light exiting the pixel and entering the lenticular array will have a sufficient lateral component that it can be totally internally reflected within the material of the lenticular array 9, and this total internal reflection is shown for example at 42.

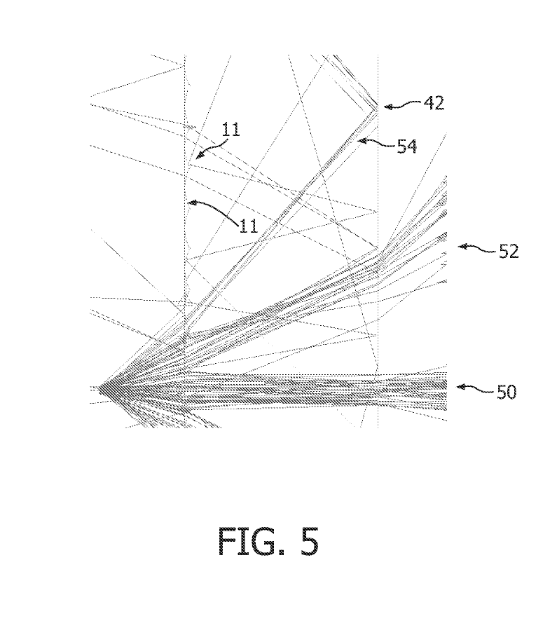

FIG. 5 shows the lens output more clearly, and shows the central view 50, and a first repetition 52. In the example of FIG. 5, a second repetition 54 is at an angle greater than the angle for total internal reflection, so that the second repetition cannot be viewed, and the configuration of FIG. 5 is limited to three views.

The light for the second repetitions is captured within the lenticular array and contributes to the loss of brightness and contrast explained above, leading to blurring and other image artefacts.

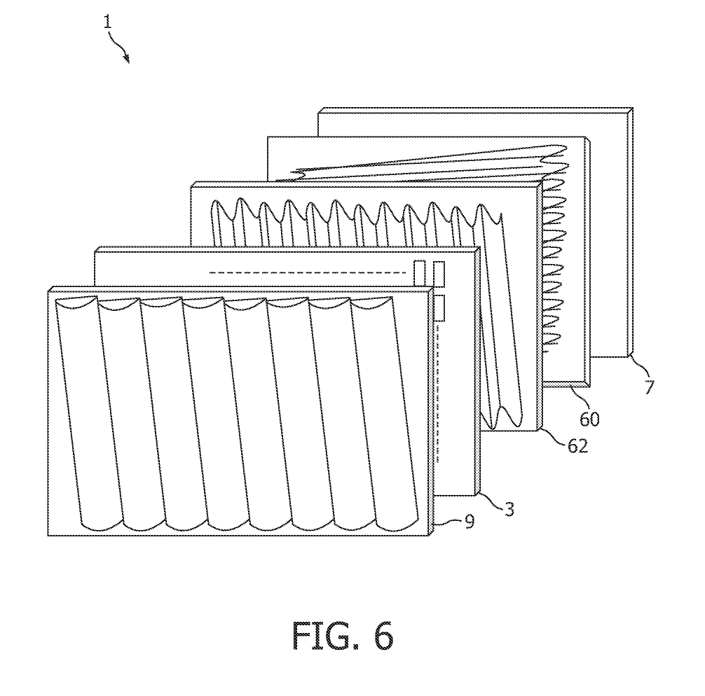

The display device of one example of the invention is shown in FIG. 6.

The device comprises a conventional backlight 7, display panel 5 and lenticular array 9. A light directing arrangement is provided at the output surface of the backlight 7 to provide a light collimating function, and comprises a first light converging arrangement 60 for converging light towards a direction normal to the display panel and having a first axis across which the light convergence is greatest and a perpendicular second axis across which the light convergence is least. In other words, the arrangement 60 provides single-axis light convergence, so that the light output from the arrangement 60 can be considered to lie within an array of parallel planes which are normal to the backlight output surface. The light converging arrangement limits the angular width of the light distribution in the direction perpendicular to the lenticulars.

A second light converging arrangement 62 again converges light towards a direction normal to the display panel and having a second axis across which the light convergence is greatest and second perpendicular axis across which the light convergence is least. The arrangement 62 thus also provides single-axis light convergence, so that the light output from the arrangement 60 can be considered to lie within an array of parallel planes which are normal to the backlight output surface. The planes of the two converging arrangements are perpendicular (crossed), so that the overall structure is two crossed single-axis light converging arrangements, and the effect of the crossed configuration is to provide two-axis convergence, namely to provide a partially collimated light output, but without loss of brightness.

The collimation of the light output from the backlight for a (single view) liquid crystal display is known. The use of a collimated backlight with an array of individual lenses of an autostereoscopic display is also disclosed in US 2004/0184145A1.

As will be apparent from the description above, perfectly collimated light is not desirable for an autostereoscopic display, as light from one pixel needs to be emitted in a non-normal direction in order to pass through the lateral lenticular elements in order to generate multiple views. The invention makes use of an imperfect light collimation function, which may be thought of as a light angle capping function, so that the range of viewing angles is not reduced, but wide angle light which would not contribute to a useful output is redirected to within the desired viewing angles.

The invention is thus based on the recognition that the angular response of the collimation function (namely the degree of collimation along different axes) should be matched to the optical function of the lenticular array. In particular, this matching should be in such a way that the amount of total internal reflection within the lenticular array should be minimized, whilst allowing the passage of light to adjacent lenticular elements for multiple images to be displayed.

This is achieved by aligning the second axis of the (or one of the) light converging arrangement (s) with the elongate axis of the lenticular elements. This means that there is convergence of light in a direction corresponding to the width direction of the lenticular elements. This is shown schematically in FIG. 6. In this way, the collimation function is used as effectively as possible to reduce the angles of light passing laterally within the lenticular array, which are the light rays giving rise to the total internal reflection as explained above.

The invention thus provides an autostereoscopic display with improved brightness levels and resolution.

The light converging arrangements 60,62 can be implemented as brightness enhancement films.

These will be well known to those skilled in the art and are widely used to provided improved backlight efficiency. They comprise prismatic microstructures which provide light redirection by reflection and refraction.

Each brightness enhancement film comprises a prismatic structure arranged in a series of grooves and peaks. The grooves of the prismatic structure extend in one direction which is parallel to the transmission axis of the brightness enhancement film. Each brightness enhancement film thus converges light in only one direction in the manner explained above. However, other single axis collimation devices may be employed and aligned in the manner of the invention.

The invention enables the undesirable artefacts caused by total internal reflection to be reduced, so that an improved brightness consistency across the display area is provided and a reduction in blurring.

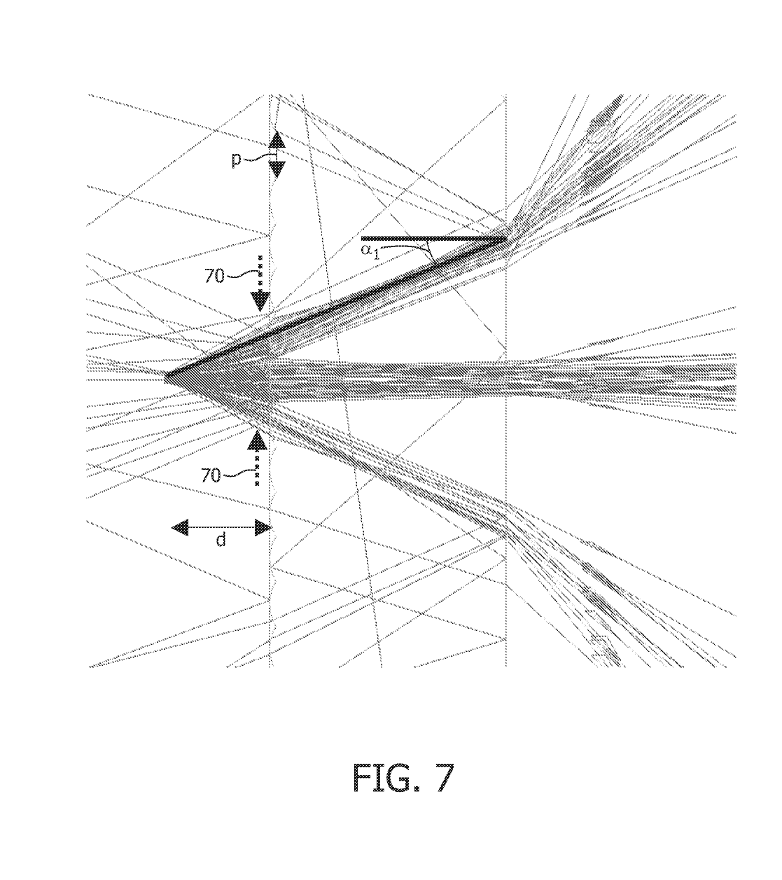

FIG. 7 shows the light ray paths for an autostereoscopic display device according to the invention, and shows the more uniform illumination from the backlight as well as the reduction in lateral light paths within the lenticular array. The dotted arrow 70 illustrate the single axis collimation direction perpendicular to the elongate lenticular direction.

The collimation enables the avoidance or near avoidance of light being refracted by the lenticular surface beyond the total internal reflection angle. Any remaining light reflections (for example Fresnel reflections) which could cause light capture in the lenticular array can be avoided/removed by means of anti-reflection coatings.

The condition that total internal reflection is to be avoided can be used to determine the level of collimation required in the direction perpendicular to the lenticular element elongate axis.

FIG. 7 shows the lenticular element pitch as p, and the effective distance between the display pixel and the lenticular array as d. This effective distance may typically be taken to be half the LCD panel thickness. α is defined as the angle between the surface normal and the light rays of a given viewing direction inside the lenticular plate. FIG. 7 shows the angle α₁ for the first view repetition, and corresponds to the angle between the effective pixel location and the first lenticular away from the normal.

For a perfectly aligned pixel and central lenticular, it can immediately be seen that:

tan α_{N}=Np/d

In fact, the lenticular elements may not be aligned perfectly with a central pixel, so that the viewing angle of the N^{th} repetition of the view (N=0, 1, 2, . . . ) depends on a relative position x (−0.5<x<0.5) of the pixel with respect to the lenticular that creates the N=0 view.

In this case, the angle can be defined as:

α_{N}=arctan [(N+x)p/d]

In FIG. 7, x=0 so that the pixel is centered with the lenticular.

In order to avoid light capture by the lenticular plate, the angle α_{N} should always be smaller than α_{TIR}=arcsin [1/n], with n the refractive index of the lenticular plate. This total internal reflection angle is the angle above which the light will be tunneled within the lenticular array.

Considering this for all possible values of x, it is possible to define the maximum allowable number of view repetitions, Nₘₐₓ:

$${N}_{MAX} = trunc [ \frac{d}{p \sqrt{{n}^{2} - 1}} - \frac{1}{2} ] . \qquad ( 1 )$$

The trunc function rounds down to the nearest integer.

Taking again into account all possible values of x, it is possible to define the maximum allowable angle of the light inside the plate:

α_{MAX}=arctan [(N_{MAX}+½)p/d]. (2)

Typical values for the parameters in equation (2) are pixel pitch p=0.4 mm, LCD to lenticular spacing d=2 mm, refractive index n=1.5. This gives Nₘₐₓ=1, and only the main view and one repetition at each side will be without total internal reflection losses. This yields α_{MAX}=31°.

In this way, the physical design of the display dictates the maximum number of view repetitions. The light collimation function then needs to ensure than no light from the pixel is generated with a sufficient angle to reach the next (forbidden) lenticular element. However, light is allowed to pass at angles below this critical angle, so that there can be display through adjacent lenticular elements. Thus, an imperfect collimation function is deliberately used and the use of the term “collimation” should be understood accordingly in this application, as indicative only of a light converging function, rather than a function which provides a unidirectional output.

In this example, total internal reflection losses can be avoided by collimating the light in the direction perpendicular to the lenticular within an angle of α_{MAX}=31, which is about 75% of the maximum total internal reflection angle of about 42°.

More generally, the maximum angle will be more than 10 degrees, and in general more than 25 degrees.

This corresponds with a collimation angle of 50° in air, and this is the requirement of the light collimator at the output of the backlight.

For the purpose of explanation, it has been assumed that the pixels do not provide any redirection of light from the backlight. If the pixels do introduce some scattering which will spread the incident light this can be taken into account, so that the maximum angle calculated is the angle of the light inside the glass of the LCD/lenticular array after it has left the pixel. The required degree of collimation above can easily be reached using the prismatic brightness enhancement films described above. These are available from 3M (Trade Mark) and are known as Vikuiti (Trade Mark) Brightness Enhancement Films.

The embodiment described above employs a liquid crystal display panel having, for example, a display pixel pitch in the range 50 μm to 1000 μm. However, it will be apparent to those skilled in the art that alternative types of display panel may be employed which use backlight illumination.

Only one type of lenticular array has been described, but the invention is applicable to other designs. For example, in order to overcome the drawback of the loss of resolution resulting from the use of a lenticular array, it has been proposed to provide a display device that is switchable between a two-dimensional mode and a three-dimensional (stereoscopic) mode.

One way to implement this is to provide an electrically switchable lenticular array. In the two-dimensional mode, the lenticular elements of the switchable device operate in a “pass through” mode, i.e. they act in the same way as would a planar sheet of optically transparent material. The resulting display has a high resolution, equal to the native resolution of the display panel, which is suitable for the display of small text characters from short viewing distances. The two-dimensional display mode cannot, of course, provide a stereoscopic image.

In the three-dimensional mode, the lenticular elements of the switchable device provide a light output directing function, as described above. The resulting display is capable of providing stereoscopic images, but has the inevitable resolution loss mentioned above.

In order to provide switchable display modes, the lenticular elements of the switchable device are formed of an electro-optic material, such as a liquid crystal material, having a refractive index that is switchable between two values. The device is then switched between the modes by applying an appropriate electrical potential to planar electrodes provided above and below the lenticular elements. The electrical potential alters the refractive index of the lenticular elements in relation to that of an adjacent optically transparent layer. A more detailed description of the structure and operation of the switchable device can be found in U.S. Pat. No. 6,069,650.

This invention can of course be applied to such a device.

The invention can be applied to displays with lenticular elements aligned with the column direction, but a preferred implementation is applied to columns which are offset. When the lenticular elements are offset from the column direction, the axis of one of the light converging devices can either be perpendicular to the column lenticular element axis, or it can be in the row direction. Thus, the two converging arrangements may be at 90 degrees, but they may instead be at an angle of (90-β) degrees where β is the angle of offset. This is intended to be within the term “substantially perpendicular”.

The foils used to converge the light along one axis are commercially available, and have accordingly not been described in detail. Similarly, the methods of manufacturing the lenticular array and indeed the display device and backlight have not been described in detail as these are routine and well known to those skilled in the art.

The use of two crossed converging arrangements improves the optical characteristics in the desired direction, namely across the width of the lenticulars, compared to the use of one converging arrangement in the desired direction. This is because the light converging arrangement has a two dimensional response and is not perform a perfectly single axis light converging function. Furthermore, the order in which the two brightness enhancement foils are mounted with respect to the backlight changes the overall optical response, so that the order will be selected to give the best optical performance, in particular the greatest attenuation beyond the desired maximum angle across the width of the lenticular elements, as well as the flattest response within the desired field of view. Thus, the ideal optical response across the width of the lenticular would be a square waveform shape, with full attenuation above the desired maximum allowed angle and uniform illumination within the desired field of view. However, the attenuation does not represent the absorption (i.e. loss) of light, but an angular redirection.

As mentioned above, a single light converging arrangement may provide the desired response.

Various other modifications will be apparent to those skilled in the art.

1. An autostereoscopic display device (1), comprising:
a display panel (3) comprising an array of rows and columns of pixels (5);
a lenticular array (9) over an output surface of the display panel, the lenticular array (9) comprising a plurality of elongate lenticular elements;
a backlight (7); and
a light directing arrangement (60) associated with the backlight (7),
wherein the light directing arrangement (60) comprises a light converging arrangement for converging light towards a direction normal to the display panel (3) and having a first axis across which the light convergence is greatest and a perpendicular second axis across which the light convergence is least, wherein the second axis of the light converging arrangement is aligned with the elongate axis of the lenticular elements,
and wherein the output of the light directing arrangement passes through the display panel to the lenticular array, the light directing arrangement controlling the range of angles of incidence to the pixels such as to reduce the angles of light passing laterally within lenticular array.

2. An autostereoscopic display device as claimed in claim 1, wherein the elongate axis of the lenticular elements is offset from the pixel column direction.

3. An autostereoscopic display device as claimed in claim 2, wherein the elongate lenticular axis is offset from the pixel column direction by less than 25 degrees.

4. An autostereoscopic display device as claimed in claim 3, wherein the elongate lenticular axis is offset from the pixel column direction by less than 15 degrees.

5. An autostereoscopic display device as claimed in claim 1, wherein the light directing arrangement further comprises a second light converging arrangement (62) for converging light towards a direction normal to the display panel and having a first axis across which the light convergence is greatest and second perpendicular axis across which the light convergence is least, and the first and second axes of the second light converging arrangement (62) are substantially perpendicular to the first and second axes of the first light converging arrangement (60).

6. An autostereoscopic display device as claimed in claim 1, wherein the or each light converging arrangement (60,62) comprises a prismatic film.

7. An autostereoscopic display device as claimed in claim 6, wherein the or each light converging arrangement (60,62) comprises a brightness enhancement film.

8. An autostereoscopic display device as claimed in claim 1 wherein the backlight is a planar backlight.

9. An autostereoscopic display device as claimed in claim 1, adapted to provide a central image (50) and a number of repetitions (52) of the image directed to different spatial locations by the lenticular array (9), the number of repetitions comprising a number N of pairs of image repetitions, wherein the maximum number of view repetitions is defined by the equation:
$${N}_{MAX} = trunc [ \frac{d}{p \sqrt{{n}^{2} - 1}} - \frac{1}{2} ]$$
wherein Nmax is the maximum number of pairs of image repetitions, n is the refractive index of the material of the lenticular array (9), d is the effective normal distance between the display panel pixels and the lenticular array, and p is the lenticular element pitch, and wherein the trunc function comprises rounding down to the nearest integer.

10. An autostereoscopic display device as claimed in claim 9, wherein the maximum angle (α) from a display pixel to a lenticular element which provides a view repetition from the pixel, normal to the display panel, is defined by the equation:
α_{MAX}=arctan [(N_{MAX}+½)p/d].

11. An autostereoscopic display device as claimed in claim 10, wherein the light converging arrangement (60) having its second axis aligned with the elongate axis of the lenticular elements is adapted to provide light collimation such that light within the lenticular array is substantially limited to light having a lateral divergence from the normal of less that the angle αMAX.

12. An autostereoscopic display device as claimed in claim 1, wherein the or each light converging arrangement (60,62) provides light convergence to within a desired maximum angle either side of the normal, and enables light paths to be formed from the backlight at all angles less than the maximum angle.

13. An autostereoscopic display device as claimed in claim 12, wherein the maximum angle is greater than 10 degrees.

14. An autostereoscopic display device as claimed in claim 13, wherein the maximum angle is greater than 25 degrees.

15. A method of providing an autostereoscopic display using a display panel (3) comprising an array of rows and columns of pixels (5) and a lenticular array (9) over an output surface of the display panel, the lenticular array comprising a plurality of elongate lenticular elements, the method comprising:
providing a light output from a backlight (7);
passing the light output through a light converging arrangement for converging light towards a direction normal to the display panel and having a first axis across which the light convergence is greatest and a perpendicular second axis across which the light convergence is least; wherein the second axis of the light converging arrangement is aligned with the elongate axis of the lenticular elements, wherein the output of the light directing arrangement is passed through the display panel to the lenticular array, wherein the lift directing arrangement controls the range of angles of incidence to the pixels such as to reduce the angles of light passing laterally within the lenticular array.
